(19) United States
(12) Patent Application Publication
(10) Pub. No.: US 2006/0263627 A1
(43) Pub. Date: Nov. 23, 2006

(54) Method for producing a coating on the surface of a particle or material, and corresponding product

(75) Inventors: Helen Grampeix, Saint Sulpice le Gueretois (FR); Manfred Kobusch, Munchen (DE); Ute Liepold, Munchen (DE)

Correspondence Address: COHEN, PONTANI, LIEBERMAN & PAVANE, 551 FIFTH AVENUE, SUITE 1210, NEW YORK, NY, 10176, US

(73) Assignee: Osram Opto Semiconductors GmbH, Regensburg (DE)

(21) Appl. No.: 10/549,010

(22) PCT Filed: Mar. 26, 2004
(86) PCT No.: PCT/DE04/00632

§ 371 Date: Sep. 13, 2005

(30) Foreign Application Priority Data
Mar. 28, 2003 (DE) 103 14 168.5

(51) Int. Cl. C09K 11/08; B05D 7/00; H01J 1/63; C09K 11/02

(52) U.S. Cl. 428/690; 427/212; 428/403; 428/917; 313/485; 252/301.4 R

(57) ABSTRACT

The invention relates to a method for producing at least one coating (3) on at least one section (4) of the surface of a body (2) by the chemical conversion of at least one constituent of the body into at least one constituent of the coating. The method is characterised in that a chemical, non-metallic compound forms the constituent of the body. The method can be described as an “intrinsic” coating method, as the coating process is not carried out by the external application of material to the surface section, but by the material conversion of the constituent of the body. The method permits the production of a body comprising at least one surface section with at least one coating that has been formed by the chemical conversion of at least one constituent of the body into at least one constituent of the coating. The body is characterised in that the constituent of the body is a chemical, non-metallic compound, for example, a chloride silicate, which is used in the form of luminescent particles as a luminescent substance in a luminescent body (7) of a light-emitting diode (LED). The coating protects the luminescent substance against decomposition by hydration or hydrolysis. The luminescent substance is characterised by improved long-term stability in comparison with similar substances in prior art.

### FIELD OF THE INVENTION

The invention relates to a process for producing a coating on the surface of a particle, for example of a phosphor particle, or of a material, by chemical conversion of at least one constituent of the phosphor particle into at least one constituent of the coating. The invention also provides an associated product, for example a phosphor powder having at least one coating which has been produced by chemical conversion of at least one constituent of the original material into at least one constituent of the coating. The product is a particle or a powder formed from particles or a material.

### PRIOR ART

A process of the type described in the introduction and a body of the type described in the introduction are known, for example, from the “passivation” of aluminum. The body in this case consists of elemental aluminum. The elemental aluminum is oxidized to form aluminum oxide (Al₂O₃) at those surface portions of the body which are brought into contact with oxygen. A coating of aluminum oxide is formed. Aluminum, the constituent of the body, is chemically converted into aluminum oxide, the constituent of the coating. The coating protects the aluminum of the body from further oxidation by oxygen.

EP 1 199 757 A2 has disclosed a body in the form of a phosphor particle which has a water-resistant coating. The body is a phosphor particle which includes a phosphor for converting an electromagnetic primary radiation into an electromagnetic secondary radiation. The phosphor absorbs the primary radiation emitted by a light-emitting diode (LED) and for its part emits the secondary radiation. A large number of phosphor particles (a phosphor powder) is cast into an epoxy housing of the LED.

A constituent of the coating of the phosphor particle may in this case be an organic material, an inorganic material and a vitreous material. A constituent of the body may be selected from the group consisting of oxide, sulfide, aluminate, borate, vanadate and silicate phosphor. The coating of the phosphor particle is in each case a water-resistant film which prevents the attack of water and therefore degradation of the phosphor.

To produce the coating, the constituents of the coating or precursors of the constituents of the coating are applied to the surface of the phosphor particle from the outside. By way of example, a sol-gel process or a CVD (Chemical Vapor Deposition) process is used for this purpose. These processes for producing the coating are time-consuming and expensive. Moreover, it is not always possible to ensure that the coating completely covers the surface of the phosphor particle. Consequently, the luminescence of the phosphor powder may be reduced.

The documents U.S. Pat. No. 5,156,885, EP-A 753 545, U.S. Pat. No. 6,447,908, U.S. Pat. No. 5,593,782, U.S. Pat. No. 4,585,673 and EP-A 928 826 have disclosed coated phosphor particles. A common feature of all these documents is that the coating is additionally added from the outside. The material for the coating is at best produced together with the phosphor particles in a single reactor, but still requires the addition of dedicated precursor materials.

### SUMMARY OF THE INVENTION

It is an object of the present invention to provide a process in accordance with the preamble of claim 1 which is simple and inexpensive. A further object is to demonstrate how a coating can be produced simply and inexpensively on a phosphor particle or pigment particle.

The characteristic features of claim 1 are used to achieve the objects. Preferred embodiments are given in the subclaims. In particular, the invention provides a process for producing a coating by chemical conversion of at least one constituent of the particle into at least one constituent of the coating. The process is characterized in that a chemical, nonmetallic compound is used as constituent of the particle.

A further object is to demonstrate how a coating can be produced simply and inexpensively on a material.

The characteristic features of claim 19 are used to achieve this object. Preferred embodiments are given in the subclaims.

In particular, the invention provides a process for producing a coating on the surface of nonmetallic materials, in which this coating or its precursor is formed by treating the material in a chemical reaction with a reactive medium in one or more steps, with at least one constituent of the material being converted into a significant constituent of the coating.

By way of example, the coating protects the material with respect to its intended conditions of use and/or has advantageous optical properties, such as minimal increase in reflectivity, a preferred absorption range for electromagnetic radiation (color) and/or interference colors and/or an improved affinity for a medium with which the material is to be coated and/or in which it is to be dispersed.

In this context, the material is in particular a compound selected from the group consisting of aluminate and/or borate and/or silicate, such as for example alkali metal and/or alkaline-earth metal silicates or alkali metal and/or alkaline-earth metal aluminates or mixtures thereof. The alkali metal and/or alkaline-earth metal elements may in this case be partially or completely substituted by main group elements, such as Sb, Sn and/or Pb, transition group elements, such as Mn, Zn and/or Cd, or rare earths (RE), such as europium. Al or Si in the abovementioned silicates or aluminates may be partially or completely substituted by Ga or In or Ge, Sn, P, Pb and/or by the transition group elements Ti, Zr, V, Nb, Ta, Cr, Mo and tungsten. Furthermore, O in the abovementioned compounds may be completely or partially replaced by N, P, PO₄³⁻, S, SO₃²⁻, SO₄²⁻, F, Cl, Br or I.

The process may in each case be referred to as “intrinsic” coating, since unlike in the known prior art the coating is not carried out by application of material to the surface portion from the outside, but rather by conversion of material of the constituent of the particle. This results in a phase boundary between the actual particle (original material) and the coating. The chemical and/or physical properties of a material of the particle and a material of the coating differ from one another.

To achieve the object, the invention also provides a powder of a pigment or phosphor which has at least one coating that has been produced by chemical conversion of at least one constituent of the original material into at least one constituent of the coating. The powder is characterized in that the constituent is a chemical, nonmetallic compound. In this context, the term phosphor is to be understood as meaning a pigment which can convert the wavelength of the incident light, in particular by the addition of a small proportion of dopants, in particular in the range from ppm up to more than 10%, to the base material. By way of example, in the case of YAG:Ce, the YAG is the base material (pure pigment) and Ce is the dopant. Both substances are economically important as a powder or as a single crystal or material.

The chemical, nonmetallic compound is to be understood as meaning a substance whose smallest unit is composed of at least two atoms of different chemical elements. The atoms of this chemical compound are bonded to one another by covalent and/or ionic, i.e. nonmetallic, bonds. An organic or organometallic compound is conceivable. However, it is preferable to use inorganic, nonmetallic compounds.

In one particular configuration, the chemical, nonmetallic compound is at least one mixed oxide selected from the group consisting of aluminate and/or borate and/or silicate. Examples of compounds of this type include alkali metal and/or alkaline-earth metal silicates or alkali metal and/or alkaline-earth metal aluminates or mixtures thereof. The alkali metal and/or alkaline-earth metal elements may in this case be partially or completely substituted by main group elements, such as Sb, Sn and/or Pb, transition group elements, such as Mn, Zn and/or Cd, or rare earths (RE), such as Eu. Al or Si in the abovementioned silicates or aluminates may be completely or partially substituted by Ga or In or Ge, Sn, P, Pb and/or by the transition group elements Ti, Zr, V, Nb, Ta, Cr, Mo and W. Furthermore, O in the abovementioned compounds may be replaced by N, P, S, F, Cl, Br or I. The classes of substances described above in this paragraph can in particular all also be used for particles and their coating, both for pigments and for phosphors.

The chemical conversion comprises any desired chemical reaction of the constituent of the body to form the constituent of the coating. By way of example, a conceivable chemical reaction is an oxidation or a reduction. The chemical reaction may also be condensation of the constituent of the body to form the constituent of the coating. In any event, chemical bonds are broken and/or formed.

The chemical conversion of the constituent of the body into the constituent of the coating can be carried out in a single step. It is preferable for the chemical conversion to take place via at least one intermediate stage. In one particular configuration, the chemical conversion of the constituent of the body into the constituent of the coating includes the following steps: a) chemical conversion of the constituent of the body into at least one precursor of the constituent of the coating, and b) chemical conversion of the precursor of the constituent of the coating into the constituent of the coating. The chemical conversion of the constituent of the body takes place via the precursor of the constituent of the coating, as an intermediate stage. In this context, it is conceivable for the chemical conversion to take place via a plurality of intermediate stages of this type.

It is preferable for the chemical conversion of the constituent of the body into the precursor of the constituent of the coating and/or the chemical conversion of the precursor of the constituent of the coating into the constituent of the coating to take place in the presence of a reactive medium. The reactive medium or a constituent of the reactive medium reacts with the constituent of the body and/or with the precursor of the constituent of the coating. The reactive medium may be in liquid or gas form.

By way of example, the body is a phosphor particle formed from a chloride-silicate. Chloride and alkaline-earth metal ions are dissolved out of the surface of the chloride-silicate by the attack of a mineral acid, such as hydrochloric acid or nitric acid, or of an organic acid, such as acetic acid. For the attack described, the reactive medium consists, for example, of an aqueous solution of the abovementioned acids. The solution includes water as solvent. However, it is in particular also conceivable to use a substantially water-free solution with a protogenic (protic), organic solvent, such as ethanol or ethylene glycol. Substantially water-free means that the level of water in the solvent is less than 5% by volume. However, it is also conceivable to use a mixture of water and/or a plurality of organic, protogenic solvents. This has various advantages. The rate at which the protective layer is formed can be controlled by varying the level of water and/or the level of the solvent with the highest dissociation constant. By adding highly viscous solvents, it is possible to set the viscosity of the mixture and therefore a diffusion constant for the reactive substance of the medium. The chemical conversion is substantially diffusion-controlled. This preferentially attacks and consequently levels any raised parts of the surface portion of the body. The surface portion is not only provided with a coating but is also polished. The result is a particularly smooth coating. A smooth coating is particularly stable with respect to the attack of a reactive substance, on account of the relatively small reactive surface area.

The dissolution of the chloride and alkaline-earth metal ions results in the formation of a layer comprising ortho-silicic acid (H₄SiO₄) or lower condensation products (oligomers) of the ortho-silicic acid, for example ortho-disilicic acid (H₆Si₂O₇), at the surface portion of the body. The ortho-silicic acid or the lower condensation products thereof remain as a (relatively) insoluble layer on the surface of the body. These substances then react, releasing water molecules, to form a condensed silica. The condensed silica is, for example, polysilicic acid (H₂ₙ₊₂SiO₃ₙ₊₁) or meta-silicic acid (H₂SiO₃)ₙ. The result is a coating of the body comprising condensed silica. The condensed silica, the constituent of the coating, is formed from the chloride-silicate, the constituent of the body, via the ortho-silicic acid, the precursor of the constituent of the coating.

The process described may lead to roughening of the surface portion of the body in the event of prolonged action of the reactive medium. This roughening is caused by further constituents of the body, the coating or the precursor of the coating being partially dissolved in the reactive medium. This may lead to incipient uneven erosion of the surface portion. The roughening may be desirable. By way of example, it alters the surface properties of the coating in such a manner that particularly good bonding (adhesion) is achieved between the coating and whatever surrounds the coating. By way of example, a phosphor powder comprising phosphor particles is cast into an epoxy resin. The bonding between the epoxy resin and the phosphor particles can be improved by influencing the roughness of the coating in a controlled way. This can lead to improved long-time stability of the assembly comprising phosphor particles and epoxy resin.

To have a controlled influence on the roughening of the coating, one particular configuration uses a reactive medium with an inhibitor which inhibits further chemical conversion of a further constituent of the body, of the precursor of the constituent of the coating and/or of the constituent of the coating. The inhibitor is preferably soluble in the reactive medium. The presence of the inhibitor substantially suppresses the further chemical conversion. This leads to uniform growth of the coating, resulting in a smooth coating. By way of example, the inhibitor is the further constituent of the coating, the precursor of the constituent of the coating or the constituent of the coating or a derivative thereof. The derivative can readily be converted into the abovementioned building blocks.

In the case of a silicate, the further constituents are silicon oxide radicals or silica. It is preferable for a silicate to be used as further constituent of the body and for silica, in particular ortho-silicic acid, to be used as inhibitor. Any desired silicate that is soluble in an aqueous medium can be used to form the ortho-silicic acid. It is preferable to use water glass as inhibitor for the formation of the ortho-silicic acid. Water glass consists of Na₄SiO₄ and/or K₄SiO₄. In aqueous solution, water glass forms ortho-silicic acid with protons of the water. The formation of the ortho-silicic acid is promoted in the acidic medium. The presence of the ortho-silicic acid in the reactive medium can not only inhibit the dissolution of silicate radicals of the body or of silica of the coating. Rather, in addition the ortho-silicic acid present in the reactive medium can also be incorporated in the coating. A reactive medium with a constituent which is incorporated in the coating is used, resulting in a particularly dense and stable coating.

In one particular configuration, at least one heat treatment of the body and/or of the coating is carried out for the chemical conversion of the constituent of the body into the precursor of the constituent of the coating and/or for the chemical conversion of the precursor of the constituent of the coating into the constituent of the coating. By way of example, the surface portion of the body is exposed to a hot, reactive medium. This inherently effects a heat treatment of the body. In the example described above, the dissolution of the chloride and alkaline-earth metal ions out of the chloride-silicate can be accelerated by treating the body with a hot solution of the acids. At the same time, the condensation of the ortho-silicic acid to form the polysilicic acid is also accelerated in this heat treatment.

A further heat treatment of the body after the chloride and alkaline-earth metal ions have been dissolved can additionally accelerate the condensing of the ortho-silicic acid to form the polysilicic acid. This further heat treatment comprises in particular calcining of the body made from chloride-silicate with a layer of ortho-silicic acid or the lower condensation products thereof. The result is a dense protective layer on the body. If a substantially water-free solvent is used, the formation of the ortho-silicic acid directly leads to the formation of higher condensation products of the ortho-silicic acid on the surface portion of the body. A relatively dense coating is formed immediately, so that the subsequent calcining can be carried out at lower temperatures or under certain circumstances can even be omitted altogether. This has the advantage that the body cannot be damaged by the calcining.

It is preferable to use a chloride-silicate as the chemical compound and a condensed silica as the constituent of the coating. In particular, the chloride-silicate has a formal composition Ca_{8-X}RE_{X}Mg(SiO₄)₄Cl₂ with 0≦X≦1. In this formula, RE denotes any desired rare earth. The rare earth is in particular Eu. In a further configuration, the rare earth is at least partially replaced by Mn.

It is preferable for the surface portion of the body to comprise the entire surface of the body. The coating is arranged on the entire surface of the body. On account of the fact that the coating is not applied externally, but rather is formed from the constituent of the body, it is simple to obtain a coating which covers the entire surface of the body.

In particular, the coating has a layer thickness selected from the nanometer range. This means that the coating may be a few tenths of an nm to a few hundred nm thick, in particular 50 to 500 nm. The layer thickness can be influenced using various process parameters, for example the reactive medium, the temperature, the reaction duration, etc. Therefore, it is also possible to obtain layer thicknesses from the micrometer range, i.e. from a few tenths of a μm up to several hundred μm.

In particular, the coating is a protective layer for preventing a chemical reaction of the constituent of the body and/or of a further constituent of the body with at least one constituent of the area surrounding the body. This surrounding area is, for example, air, the constituent of the air is water and the body consists of a hydrolyzable material. The process produces a hydrophobic coating on the surface of the body. The hydrophobic coating prevents hydration and possibly subsequent hydrolyzing and therefore decomposition of the hydrolyzable material. The body can therefore be stored or used even in a moist environment.

In one particular configuration, the body includes a phosphor for converting an electromagnetic primary radiation into an electromagnetic secondary radiation. The body is a phosphor particle of a phosphor powder. The phosphor particles of the phosphor powder are, for example, cast into a conversion layer of an LED formed from an epoxy resin. The LED emits the electromagnetic primary radiation, which is absorbed by the phosphor and converted into the electromagnetic secondary radiation. By way of example, the LED emits primary radiation with a wavelength from the UV or visible spectral region. It is conceivable in particular to use a primary radiation with a wavelength from the blue spectral region. By way of example, an LED with a primary radiation of this type has a semiconductor layer of gallium indium nitride (GaInN) as “active” layer. An intensity maximum of the primary radiation is at approximately 450 nm.

The coating of the phosphor particles is substantially transparent to the primary radiation and the secondary radiation. The primary radiation and the secondary radiation can pass through the coating. This is achieved in particular by virtue of the fact that very small layer thicknesses of the coating can be achieved using the proposed production process. On account of the low layer thickness, the absorbance of the coating is low for the primary radiation and the secondary radiation (the transmission is high).

To summarize, the present invention results in the following advantages:
The coating is formed by chemical conversion of a constituent of the body at the surface portion of the body. Accordingly, it is possible to achieve more homogeneous coating of the surface portion of the body compared to the prior art.
A thin, homogeneous and dense coating with a layer thickness in the nanometer range is achievable.
The thin coating allows the chemical stability (inertness) of the body with respect to a reactive constituent of a surrounding environment to be considerably improved.
If a reactive medium with a low-water or water-free solvent or an inhibitor is used, it is possible to have a controlled influence on the surface properties of the coating.
The process described can very easily be combined with a process for producing the coating of the surface portion of a body in which the coating is applied to the surface of the body from the outside.
In particular a phosphor powder comprising coated phosphor particles is achievable. The phosphor particles are resistant to atmospheric humidity. The luminescence property of the phosphor particles is scarcely influenced by the coating and remains substantially unreduced even over a prolonged period of time.
The process can easily be integrated in an existing process for producing any desired body. By way of example, washing processes are carried out a number of times during the production of phosphor particles. These washing processes may be supplemented by wet-chemical treatments of the phosphors.

### BRIEF DESCRIPTION OF THE DRAWINGS

A process for producing the coating on a surface portion of the body and a body having the coating are presented on the basis of a plurality of exemplary embodiments and the associated figures. The figures are diagrammatic and not to scale.

FIG. 1 shows an excerpt of a cross section through a coated phosphor particle.

FIG. 2 shows an excerpt from an LED with a luminescence conversion layer comprising phosphor particles.

FIG. 3 shows a process for producing the coating on a surface portion of a phosphor particle.

FIG. 4 shows the hydrolysis rate of a phosphor powder comprising phosphor particles with and without coating.

FIG. 5 shows a coated phosphor powder at various levels of magnification.

FIG. 6 shows, for a coated phosphor powder, the comparison of the quantum efficiency and reflectivity with an uncoated phosphor powder.

### PREFERRED EMBODIMENTS OF THE INVENTION

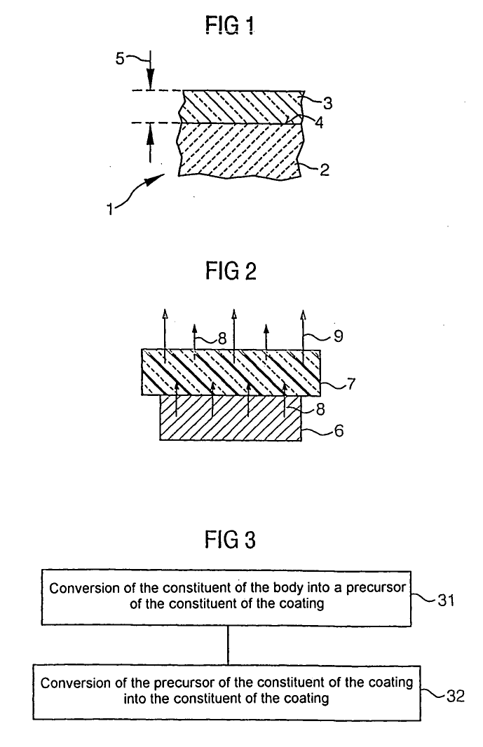

The coated body 1 is a phosphor particle of a phosphor powder (FIG. 1). The body (phosphor particle) 2 has the coating 3 on the surface portion 4. The surface portion comprises the entire surface of the body 2. The body 2 is completely surrounded by the coating 3. The constituent of the body 2 is the chemical compound chloride-silicate having the formal composition Ca_{8-X}Eu_{X}Mg(SiO₄)₄Cl₂ with 0≦X≦1. The coating 3 consists of a condensed silica. The layer thickness 5 of the coating is from the nanometer range.

The coating 3 on the surface portion of the phosphor particle 2 is formed by chemical conversion of the chloride-silicate of the phosphor particle 2 into an ortho-silicic acid or into a lower condensation product of ortho-silicic acid (precursor of the constituent of the coating 3, cf. FIG. 3, reference numeral 31). For this purpose, first of all Ca, Mg, Eu and Cl fractions are dissolved out of the chloride-silicate by the action of an acid. In the process, a layer of ortho-silicic acid or lower condensation products of ortho-silicic acid is formed in situ on the surface portion 4 of the phosphor particle 2. Then the ortho-silicic acid or the lower condensation products of ortho-silicic acid is/are converted into the coating 3 of condensed silica (cf. FIG. 3, reference numeral 32). Condensation of the precursor of the constituent of the coating 3 takes place as chemical conversion. The condensation is driven by calcining of the phosphor particles 2 coated with the precursor. The coated phosphor particles 1 are used in a luminescence conversion body 7 of an LED 6. The active semiconductor layer of the LED 6 is GaInN. The luminescence conversion body 7 consists of epoxy resin in which the phosphor particles 1 are embedded. The phosphor of the phosphor particles 1 absorbs the electromagnetic primary radiation 8 from the blue spectral region (emission maximum at approx. 450 nm) emitted by the LED and for its part emits electromagnetic secondary radiation 9 from the green spectral region. Since the primary radiation 8 partially passes through the luminescence conversion body 7, the result is a blue-green mixed color formed from the primary and secondary radiation. On account of the coating 3, the phosphor particles 1 have a high long-term stability. Therefore, even prolonged operation of the LED 6 with the luminescence conversion body 7 causes virtually no shift in the color locus. By way of example, a structure similar to that described in U.S. Pat. No. 5,998,925 is used for application in a white LED together with a GaInN chip.

### Exemplary Embodiment 1

To apply the coating 3, 10 g of the phosphor powder are introduced into a glass vessel with stirrer together with 200 ml of water at a temperature of 80° C. The pH is controlled at this temperature by the addition of an approximately 3 molar mineral acid (hydrochloric acid). Alternatively, the pH is set with the aid of an organic acid (acetic acid). The pH is held at 8.3. After approximately 2 ml of acid have been added and a treatment time of 2 minutes, the pH is approximately reached. Then, further acid is added very slowly at this pH. The treatment is terminated after 20 minutes. The phosphor powder obtained is filtered and dried. This is followed by a heat treatment of the phosphor powder. The powder is calcined in vacuo at 300° C. for two hours.

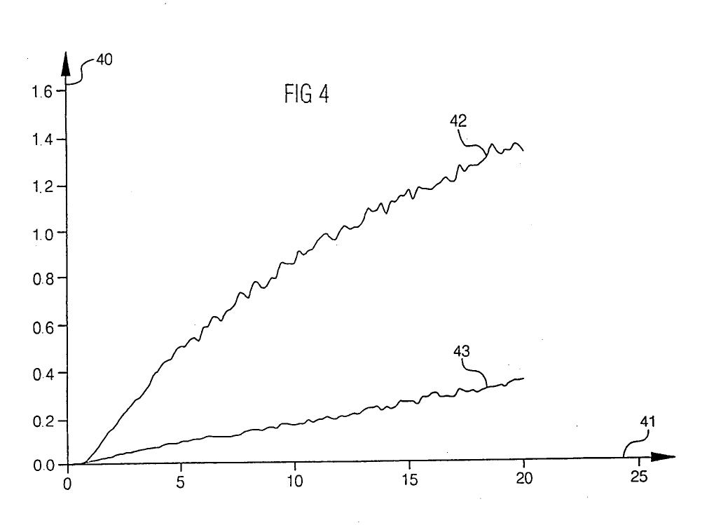

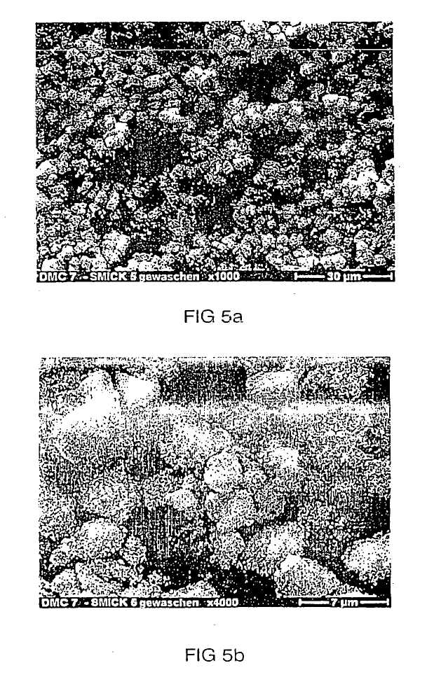

FIG. 4 shows how the proportion 40 of hydrolyzed chloride-silicate changes in % with the reaction time 41 (duration of hydrolysis) in s when the phosphor powder is in an aqueous environment. The proportion 40 of hydrolyzed chloride-silicate is a measure of the hydrolysis rate and therefore of the long-term stability of the phosphor powder. The figure plots the change in the proportion 42 of hydrolyzed chloride-silicate in uncoated phosphor particles comprising the chloride-silicate over the course of time and the change in the proportion 43 of hydrolyzed chloride-silicate in coated phosphor particles comprising the chloride-silicate over the course of time. The hydrolysis rate is significantly reduced by the coating 3. FIG. 5 shows a coated phosphor powder at various levels of magnification. The surface is not smooth and uniform, but rather is unevenly textured on account of the conversion and partial dissolution of the original layer. The resulting layer is reminiscent of growths resembling cauliflowers. The layer is crumbly and rough and does not have a constant layer thickness. The layer thicknesses referred to here are always maximum layer thicknesses. With other materials and the use of other additives rather than those indicated here, it is also possible to produce a more or less smooth surface rather than a crumbly surface. The layer thicknesses which can be achieved in total are up to 1000 nm.

### Exemplary Embodiment 2

10 g of the phosphor powder are introduced into a glass vessel with stirrer together with 200 ml of water-free ethylene glycol at a temperature of 60° C. The formation of the coating 3 is controlled under the continuous addition of small quantities of water-free acetic acid. The total quantity of acetic acid is such that approximately 10% of the phosphor powder is converted within 30 min. The phosphor particles 2 obtained after the addition of acetic acid has ended already have coatings 3. These coated phosphor particles are filtered, rinsed with ethanol, and dried for several hours in air at approximately 125° C. and for several ours in vacuo at 250° C.

### Exemplary Embodiment 3

As an extension to Exemplary Embodiment 1, 1 g to 3 g of 20% strength water glass solution is added in addition to the hydrochloric acid. This results in ortho-silicic acid being present in the reactive medium, which as an inhibitor inhibits the removal of the silica from the surface portion of the phosphor particles. At the same time, the orthosilicic acid is incorporated into the coating 3. This promotes uniform growth of the coating.

### Exemplary Embodiment 4

Production of an intrinsic gallium oxide coating on a thiogallate phosphor according to the following basic principle. Under defined and controlled pH conditions, the thiogallate phosphor is partially hydrolyzed at the surface (step 1). In the process, a gallium hydroxide layer thickness which can be set in a defined way is formed on the surface as a function of the treatment conditions. This layer is then converted (step 2) into gallium oxide in a tempering step:
SrGa2S4+3H2O+2HCOOH->2Ga(OH)3↓+4H2S↑+Sr2++2COOH— (1)
2Ga(OH)3->Ga2O3+3H2O↑ (2)
Execution: 500 ml of 0.5 N sodium acetate solution are placed in a reaction vessel with gas introduction/frit, stirrer, heating and pH electrode and heated to 40-80° C., preferably 55° C. After the addition of 10 g of thiogallate phosphor, e.g. strontium thiogallate, by way of example formic acid (alternatively acetic acid or hydrochloric acid) is metered in with vigorous stirring and introduction of gas (nitrogen) using a metering device until a pH of between 3 and 6, preferably 4.6, is reached. The metering of formic acid is set in such a way as to maintain a pH of between 3.5 and 5.5, preferably between 4.4 and 4.8. Depending on the desired layer thickness (which is imposed by the required provision of stability combined with a minimal increase in reflectivity), the treatment is carried out for between 15 minutes and 6 hours, preferably between 30 minutes and 60 minutes. The phosphor which has been coated in this way is filtered, washed with an alcohol, preferably 97% strength ethanol, and dried at between 80° and 250°, preferably at 150°, if appropriate in vacuo.

The dried phosphor is calcined under flowing shielding gas (preferably nitrogen) at a flow rate of between 1 and 100 ml/min, preferably between 10 and 20 ml/min, and a temperature of between 250° C. and 800° C., preferably between 650 and 700° C., for 1 to 12 hours, preferably between 2 and 3 hours. The coated phosphor formed is then ready for use.

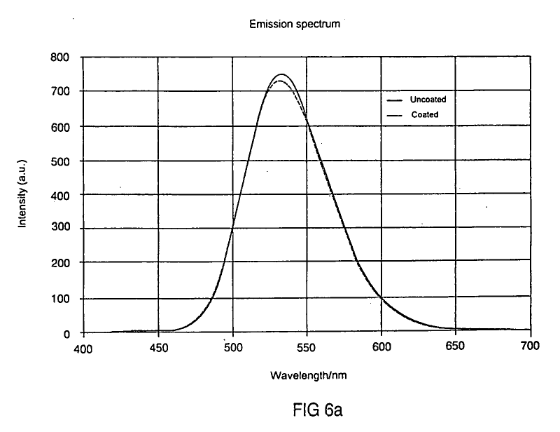

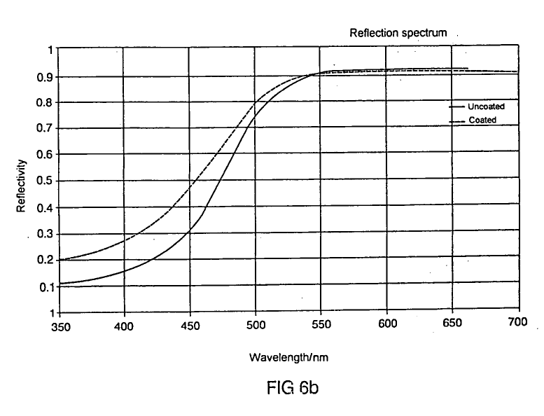

One specific example is shown in FIG. 6, which shows the quantum efficiency and reflectivity of a phosphor of the (Ba, Ca, Mg) thiogallate type, specifically on the one hand a comparison of the emission spectrum (uncoated and coated) and of the reflection spectrum (likewise uncoated and coated). The coating improves the phosphor properties in the following way: the efficiency rises from 82.1% to 84.9%, based on excitation at 400 nm; the reflectivity increases from 15.4% to 27%, once again based on excitation at 400 nm.

### Exemplary Embodiment 5

As with a silicate-containing phosphor particle, in particular based on chloride-silicate, it is possible to obtain a protective layer of SiO₂, so in the case of an aluminate-containing phosphor particle it is possible to produce a protective layer of Al₂O₃. In the case of a borate, boron oxide can be produced as the layer.

1. A process for producing a coating (3) on the surface (4) of a pigment or phosphor particle (2), characterized in that the coating is produced by chemical conversion of at least one original constituent of the phosphor particle (2) into at least one constituent of the coating (3), with a chemical, nonmetallic compound being used as the original constituent of the phosphor particle (2).

2. The process as claimed in claim 1, in which the chemical conversion of the constituent of the particle (2) into the constituent of the coating (3) includes the following steps:
a) chemical conversion of the constituent of the particle into at least one precursor of the constituent of the coating (31), and
b) chemically converting the precursor of the constituent of the coating into the constituent of the coating (32)

3. The process as claimed in claim 2, in which the chemical conversion of the constituent of the particle into the precursor of the constituent of the coating and/or the chemical conversion of the precursor of the constituent of the coating into the constituent of the coating takes place in the presence of a reactive medium.

4. The process as claimed in claim 1, in which at least one heat treatment, in particular tempering, of the particle and/or the coating is carried out for the chemical conversion of the constituent of the particle into the precursor of the constituent of the coating and/or for the chemical conversion of the precursor of the constituent of the coating into the constituent of the coating.

5. The process as claimed in claim 3, in which a reactive medium is used together with an inhibitor which inhibits further chemical conversion of a further constituent of the body, the precursor of the constituent of the coating and/or the coating.

6. The process as claimed in claim 5, in which a silicate is used as constituent of the particle and silica is used as inhibitor.

7. The process as claimed in claim 3, in which a reactive medium with a constituent which is incorporated in the coating is used.

8. A powder consisting of particles of a pigment or phosphor having a coating (3) which has been produced by chemical conversion of at least one constituent of the body (2) into at least one constituent of the coating (3), characterized in that the constituent of the particle (2) is a chemical, nonmetallic compound.

9. The powder as claimed in claim 8, in which the entire surface of the particles is covered with a coating with a fluctuating layer thickness, and the texture of the coating is in particular rough and crumbly like that of a cauliflower.

10. The powder as claimed in claim 8, in which the coating (3) has a layer thickness (5) selected from the nm range, in particular 50 to 1000 nm, especially up to 500 nm.

11. The powder as claimed in claim 8, in which the coating (3) is a protective layer.

12. The powder as claimed in claim 8, in which the chemical, nonmetallic compound is at least one mixed oxide selected from the group consisting of aluminate and/or borate and/or silicate.

13. The powder as claimed in claim 12, in which the silicate is a chloride-silicate.

14. The powder as claimed in claim 13, in which the chloride-silicate has a formal composition Ca_{8-X}RE_{X}Mg(SiO₄)₄Cl₂ with 0≦X≦1, in which RE is a rare earth.

15. The powder as claimed in claim 14, in which the rare earth RE is at least partially replaced by Mn.

16. The powder as claimed in claim 15, in which the rare earth is Eu.

17. The powder as claimed in claim 8, in which the constituent of the coating (3) is condensed silica.

18. An LED comprising the phosphor powder as claimed in claim 8, in which the phosphor is exposed to an electromagnetic primary radiation and is used to partially or completely convert the primary radiation (8) of the LED into an electromagnetic secondary radiation (9).

19. A process for producing a coating (3) on the surface (4) of nonmetallic materials, in which this coating or its precursor is formed by the material being treated in a chemical reaction with a reactive medium in one or more steps, characterized in that at least one constituent of the material is converted into a significant constituent of the coating.

20. The process as claimed in claim 19, characterized in that the coating is produced by chemical conversion of at least one original constituent of the surface of the material (2) into at least one constituent of the coating (3), with a chemical, nonmetallic compound being used as the original constituent of the phosphor particle (2)

21. The process as claimed in claim 19, characterized in that the material is a compound selected from the group consisting of aluminate and/or borate and/or silicate, in particular alkali metal and/or alkaline-earth metal silicates or alkali metal and/or alkaline-earth metal aluminates or mixtures thereof.

22. The process as claimed in claim 20, characterized in that alkali metal and/or alkaline-earth metal elements are partially or completely substituted by main group elements, such as Sb, Sn and/or Pb, transition group elements, such as Mn, Zn and/or Cd, or rare earths (RE), such as europium.

23. The process as claimed in claim 21, characterized in that Al or Si in the abovementioned silicates or aluminates are partially or completely substituted by Ga or In or Ge, Sn, P, Pb and/or by the transition group elements Ti, Zr, V. Nb, Ta, Cr, Mo and tungsten.

24. The process as claimed in claim 21, characterized in that the oxygen 0 in the abovementioned compounds is completely or partially replaced by N, P, PO₄³⁻, S, SO₃²⁻, SO₄²⁻, F, Cl, Br, or I.
